(19) United States
(12) Patent Application Publication
(10) Pub. No.: US 2020/0245073 A1
(43) Pub. Date: Jul. 30, 2020

(54) FREQUENCY RESPONSE OPTIMIZATION FOR QUASI-RIBBON AUDIO SPEAKER

(71) Applicant: AYERS ELECTRONIC SYSTEMS, LLC, Richmond, VA (US)

(72) Inventor: MARILYN R.K. FORTIN, CHESTERFIELD, VA (US)

(21) Appl. No.: 16/740,226

(22) Filed: Jan. 10, 2020

Related U.S. Application Data
(60) Provisional application No. 62/796,972, filed on Jan. 25, 2019.

(51) Int. Cl. H04R 9/04; H04R 7/18; H04R 7/04; H04R 9/02; H04R 9/06

(52) U.S. Cl. CPC H04R 9/048; H04R 7/18; H04R 2307/025; H04R 9/025; H04R 9/06; H04R 7/04

(57) ABSTRACT

A quasi-ribbon speaker comprises a perforated planar metal sheet, a plurality of parallel, spaced-apart elongated magnetic bars mounted to the metal sheet in an alternating pole arrangement, a flexible planar diaphragm positioned parallel to the metal sheet, and a plurality of electronic traces affixed to the diaphragm. Except at each of one or more areas of resonance, the electronic traces are parallel to each other and each electronic trace is positioned above a corresponding gap between two adjacent magnetic bars. At each of the one or more areas of resonance a portion of one or more electronic traces is positioned partly or fully overlapping a portion of one or more of the magnetic bars.

### CROSS-REFERENCE TO RELATED APPLICATIONS

This application claims priority to pending U.S. Provisional Application Ser. No. 62/796,972, filed Jan. 25, 2019, the contents of which are incorporated herein by reference in its entirety.

### FIELD OF THE INVENTION

This invention relates to audio speakers, and more specifically to quasi-ribbon audio speakers.

### BACKGROUND

A quasi-ribbon audio speaker is a high-end flat panel audio speaker. A quasi-ribbon speaker has an overall planar structure, and is typically positioned upright for use.

A quasi-ribbon speaker comprises a rear layer having a perforated metal planar sheet with a plurality of parallel, spaced-apart magnets mounted to the perforated metal sheet. The magnets are arranged with alternating poles. That is, every other magnet has its north pole placed against the perforated metal sheet and its south pole positioned away from the perforated metal sheet, and each alternating interspersed magnet has its south pole placed against the perforated metal sheet and its north pole positioned away from the perforated metal sheet. This alternating pole arrangement is illustrated in FIG. 2 where ‘N’ indicates the north pole is positioned away from the perforated metal sheet and ‘S’ indicates the south pole is positioned away from the perforated metal sheet.

A quasi-ribbon speaker further comprises a front layer that is parallel to and spaced apart from the rear layer. The front layer has a flexible planar diaphragm with conductive, electronic traces (typically copper) affixed thereto. The electronic traces may comprise any suitable conductive material and may be affixed to the diaphragm in any suitable manner. The diaphragm is stretched tightly within a frame. The diaphragm is typically constructed of any thin, non-conductive material, such as a polymer sheet.

The electronic traces are electrically connectable to an audio signal source. When an audio signal is provided to the electronic traces, the diaphragm vibrates and produces the desired sound.

Often, one or more areas of undesirable acoustic resonance are present at various locations on the speaker. Conventionally, it is known to reduce or eliminate these resonances by inserting a fastener (typically a screw which may be fastening a disc, such as a washer to the face of the diaphragm) through the front layer and into the rear layer at each area of resonance, which reduces the vibration of the diaphragm at those areas and thereby reduces or eliminates the resonance.

While this conventional method of reducing or eliminating resonances may be reasonably effective, the visibility of one or more fasteners on the front panel of the speaker takes away from the sleek esthetic and is undesirable in such high-end speakers.

### BRIEF SUMMARY OF THE DISCLOSURE

In one embodiment of the invention, a quasi-ribbon speaker comprises a perforated planar metal sheet, a plurality of parallel, spaced-apart elongated magnetic bars mounted to the metal sheet in an alternating pole arrangement, a flexible planar diaphragm positioned parallel to the metal sheet, and a plurality of electronic traces affixed to the diaphragm. Except at each of one or more areas of resonance, the electronic traces are parallel to each other and each electronic trace is positioned above a corresponding gap between two adjacent magnetic bars. At each of the one or more areas of resonance a portion of one or more electronic traces is positioned partly or fully overlapping a portion of one or more of the magnetic bars.

The quasi-ribbon speaker may further comprise an edge band affixed to an outer perimeter of the diaphragm to enable tensioning of the diaphragm. The edge band may comprise a dielectric substrate.

The plurality of electronic traces may be a first plurality of electronic traces affixed to a first side of the diaphragm, and the quasi-ribbon speaker may further comprise a second plurality of electronic traces affixed to a second side of the diaphragm. The first plurality of electronic traces and the second plurality of electronic traces may be positioned fully back-to-back. Except at each of the one or more areas of resonance, the first plurality of electronic traces and the second plurality of electronic traces may be positioned back-to-back.

In an alternative embodiment of the invention, a quasi-ribbon speaker comprises a perforated planar metal sheet, a plurality of parallel, spaced-apart elongated magnetic bars mounted to the metal sheet in an alternating pole arrangement, a flexible planar diaphragm positioned parallel to the metal sheet, a first plurality of electronic traces affixed to a first side of the diaphragm, and a second plurality of electronic traces affixed to a second side of the diaphragm.

In another alternative embodiment of the invention, a quasi-ribbon speaker comprises a perforated planar metal sheet, a plurality of parallel, spaced-apart elongated magnetic bars mounted to the metal sheet in an alternating pole arrangement, a flexible planar diaphragm positioned parallel to the metal sheet, a plurality of electronic traces affixed to the diaphragm, and an edge band affixed to an outer perimeter of the diaphragm to enable tensioning of the diaphragm.

In addition to the quasi-ribbon speakers, as described above, alternative embodiments of the invention comprise methods for constructing a quasi-ribbon speaker and methods for tensioning a diaphragm of a quasi-ribbon speaker as described herein.

### BRIEF DESCRIPTION OF THE SEVERAL VIEWS OF THE DRAWINGS

Reference will now be made to the accompanying drawings, which are not necessarily drawn to scale. The following detailed description of the disclosure will be better understood when read in conjunction with the appended drawings. It should be understood, however, that the disclosure is not limited to the precise arrangements and instrumentalities shown. In the drawings:

FIG. 1 is a front view of a quasi-ribbon speaker, in accordance with embodiments of the present invention.

FIG. 2 is a cross section view of the quasi-ribbon speaker of FIG. 1 along section line A-A.

FIG. 3 illustrates detail D of FIG. 2 along section line A-A.

FIG. 4 is a front view of the quasi-ribbon speaker of FIG. 1 showing section line B-B.

FIG. 5 is a perspective section view of the quasi-ribbon speaker of FIG. 1 along line B-B.

FIG. 6 illustrates detail C of FIG. 5.

FIG. 7 is a rear view of a quasi-ribbon speaker, in accordance with alternative embodiments of the present invention.

FIG. 8 is a cross section view of the quasi-ribbon speaker of FIG. 7 along any line at which the electronic traces are conventionally positioned.

FIG. 9 illustrates detail F of FIG. 8.

FIG. 10 is a cross section view of a quasi-ribbon speaker along any line at which the electronic traces are conventionally positioned, in accordance with alternative embodiments of the present invention.

FIG. 11 illustrates detail E of FIG. 10.

### DETAILED DESCRIPTION OF THE DISCLOSURE

Certain terminology is used in the following description for convenience only and is not limiting. The words “lower,” “bottom,” “upper,” and “top” designate directions in the drawings to which reference is made. The words “inwardly,” “outwardly,” “upwardly” and “downwardly” refer to directions toward and away from, respectively, the geometric center of the device, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

The structural arrangement of components is described herein based on the speaker being in its upright position for use.

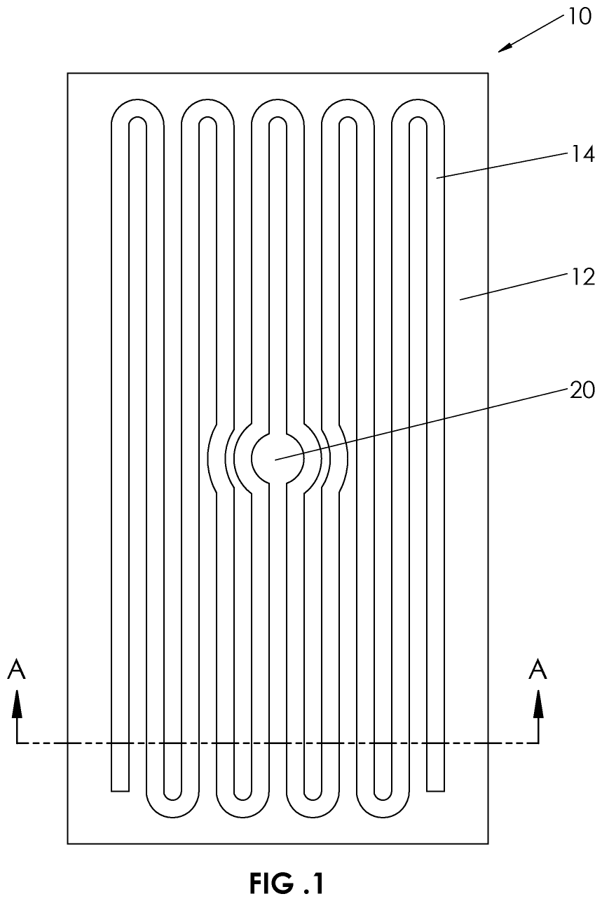

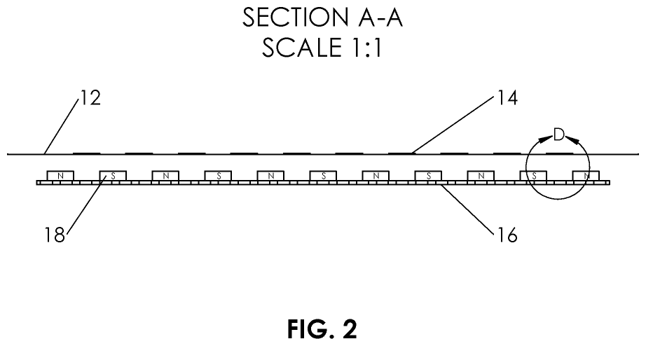

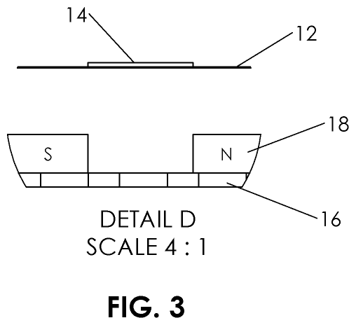

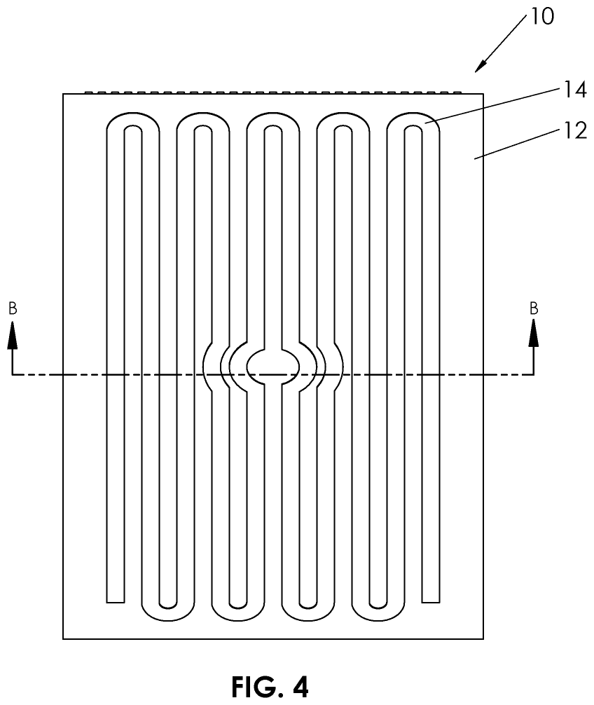

Embodiments of the invention are directed to a quasi-ribbon audio speaker having an improved structure for reducing or eliminating resonances. Referring now to FIGS. 1-6, a quasi-ribbon speaker 10 comprises a rear layer and a front layer. The rear layer comprises a perforated metal planar sheet 16 (the pattern of perforation of the metal sheet is not limited to the pattern shown in the figures) with a plurality of parallel, spaced-apart elongated magnetic bars 18 mounted to the perforated metal sheet. As with conventional quasi-ribbon speakers, the magnets are arranged with alternating poles (as illustrated in FIG. 2). Any suitable type, size, and thickness of metal sheet may be used. Any suitable type, size, and number of magnet may be used. The front layer of the quasi-ribbon speaker 10 is parallel to and spaced apart from the rear layer. The front layer comprises a flexible planar diaphragm 12 with electronic traces 14 (typically copper, although any metal or alloy with appropriate properties may be used) affixed thereto. While the electronic traces are formed from one uninterrupted conductor that comprises a plurality of elongated, parallel portions with curved portions joining alternating ends of each parallel portion to an adjacent parallel portion, the term “electronic traces” is conventionally understood to mean only the elongated, parallel portions and not the curved portions. Such conventional usage is employed herein. While the illustrated diaphragm is rectangular, any suitable size and shape diaphragm may be used. The diaphragm is stretched tightly within a frame. The diaphragm and electronic traces may be formed from a thin copper layer adhered to a polymer sheet, such as in Dupont® Pyralux®. Some of the copper layer is etched away leaving electronic traces in a desired pattern. However, any suitable material and construction technique may be used for the diaphragm and electronic traces.

In conventional quasi-ribbon speakers, the elongated parallel segments of the electronic traces are positioned above the gaps between the magnetic bars (as seen in FIG. 2). In the quasi-ribbon speaker of embodiments of the invention, a portion of one or more of the elongated parallel segments of the electronic traces is positioned partly or fully above one or more of the magnetic bars at or near each area of resonance. The size of each area of resonance may vary considerably. That is, at or near each area of resonance a portion of one or more of the elongated parallel segments of the electronic traces is not positioned in its conventional location above the gaps between the magnetic bars. By positioning a portion of the electronic traces partly or fully above the magnetic bars at or near each area of resonance, the vibration is reduced at that area and therefore the resonance is reduced or eliminated.

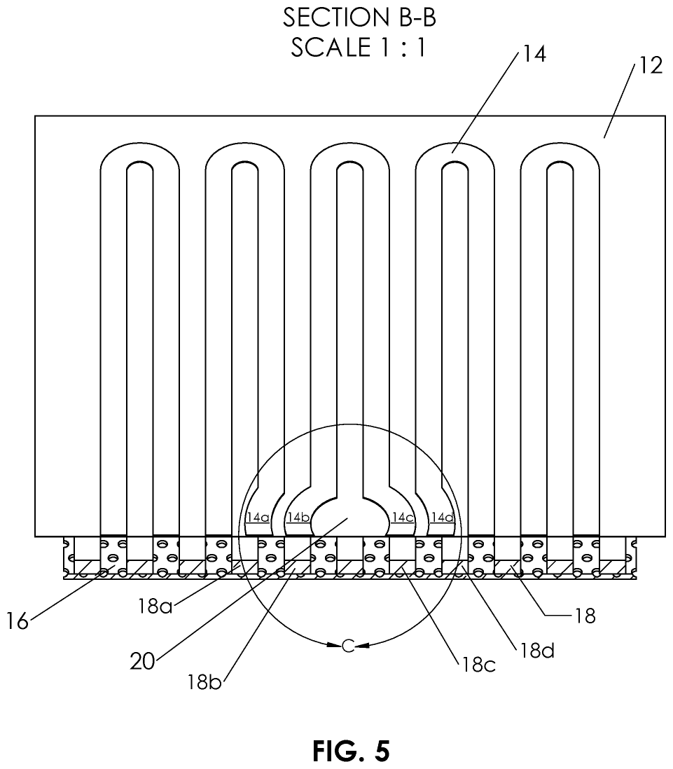

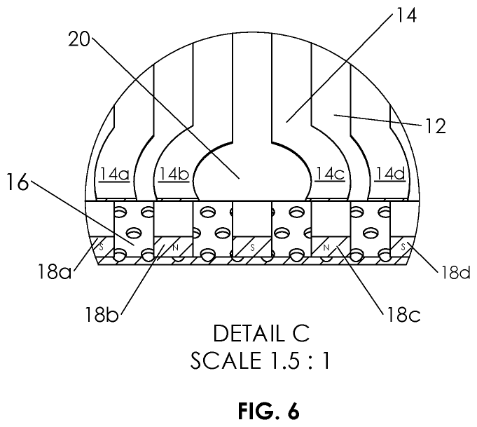

As an example, FIGS. 1, 4, 5, and 6 show a portion of each of four different elongated parallel segments of the electronic traces have been positioned partly above a corresponding magnetic bar around an area of resonance 20. As best seen in FIGS. 5 and 6, the two elongated parallel segments 14b, 14c of the electronic traces closest to the area of resonance 20 each have a portion that is positioned fully or almost fully over the respective corresponding magnetic bars 18b, 18c, while the two adjacent elongated parallel segments 14a, 14d further away from the area of resonance 20 are not positioned as fully over the respective corresponding magnetic bars 18a, 18d. In this regard, the positioning of segments 14b, 14c provides more dampening than the positioning of segments 14a, 14d, which makes sense as more dampening would typically be needed closer to the area of resonance 20.

The amount by which any particular elongated parallel segment is positioned over a respective corresponding magnetic bar may vary depending on the amplitude of the resonance to be addressed. Additionally, the number of elongated parallel segments that are positioned over a respective corresponding magnetic bar may vary depending on the amplitude of the resonance to be addressed.

Any needed variance of positioning of the electronic traces would typically be determined experimentally for each specific speaker design (e.g., speaker size, diaphragm material, magnet type and size, etc.). A prototype of a specific speaker design is built and tested to determine the location and amplitude of any resonance(s). Based on the location and amplitude of any determined resonance(s), the design of the electronic traces would be modified to reposition one or more portions of one or more elongated parallel segments at or near each area of resonance. It may be necessary to build a prototype of the revised design to determine if the modified positioning of the electronic traces has eliminated or sufficiently reduced the resonance(s). Iterative design changes may be needed to determine the precise positioning of the electronic traces needed to eliminate or sufficiently reduce the resonance(s). Although not currently implemented, computer modeling may be used in the future to determine the precise positioning of the electronic traces needed to eliminate or sufficiently reduce the resonance(s) without requiring experimentation.

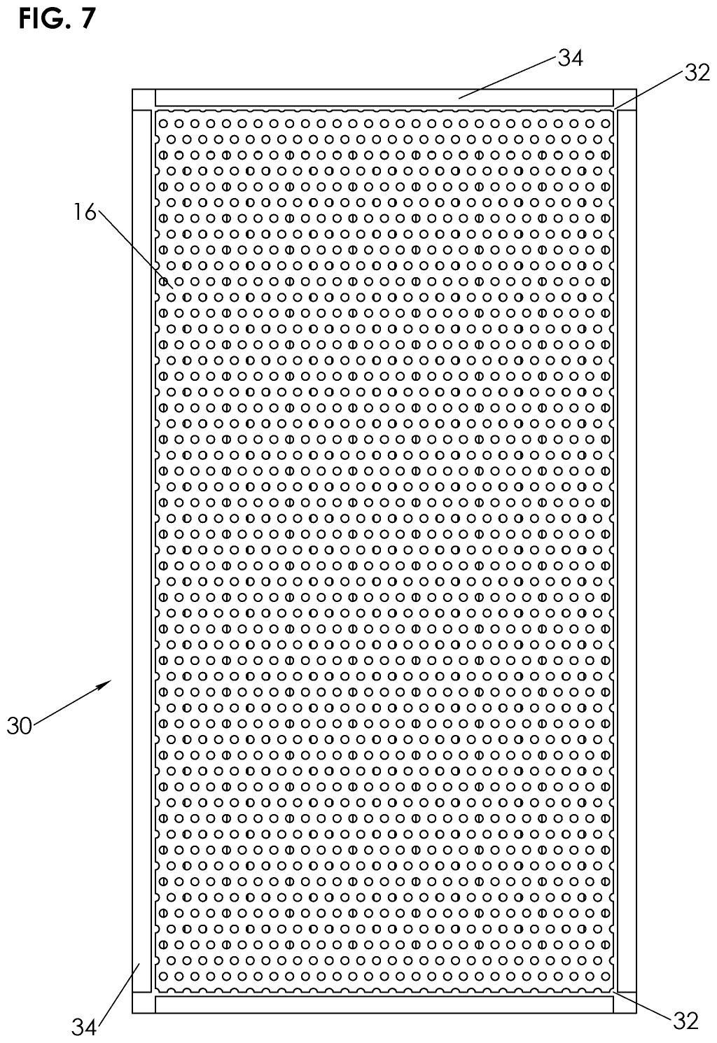

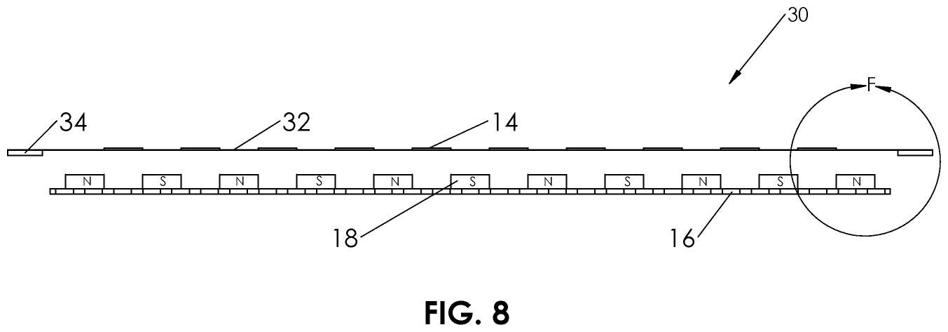

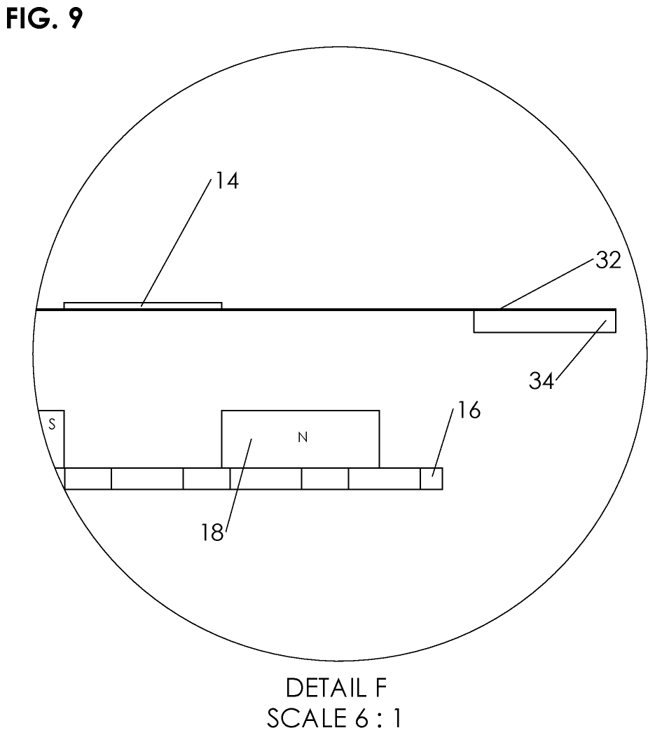

Referring now to FIGS. 7-9, an alternative embodiment of the invention is illustrated. FIGS. 7-9 illustrate a quasi-ribbon speaker 30 that comprises a rear layer and a front layer. The rear layer comprises a perforated metal planar sheet 16 with a plurality of parallel, spaced-apart elongated magnetic bars 18 mounted to the perforated metal sheet. The front layer comprises a flexible planar diaphragm 32 with electronic traces 14 (typically copper) affixed thereto. The diaphragm is stretched tightly within a frame. To assist with stretching the diaphragm appropriately, a reinforcing dielectric substrate 34 (which may be termed an edge band) may be affixed to the edges of the diaphragm 32. While the edge band is shown on all four edges of the diaphragm, the edge band can be used along any edge where tensioning is needed and can be left off where tensioning is not desired. The reinforcing dielectric substrate 34 may comprise an FR4 stiffener (which is conventionally used with PC boards) or the like. The reinforcing dielectric substrate 34 may comprise inner and outer edge bands. Although not illustrated, the reinforcing dielectric substrate 34 may have a plurality of holes defined therein (typically in the outer edge band) for temporarily attaching tension meters during installation of the diaphragm within the frame. The diaphragm 30 is positioned in the frame and tensioned, using tension meters to set the desired amount of tension. Once the desired amount of tension is applied, the diaphragm may be affixed to the frame (typically using screws secured through the inner edge band with or without adhesive between the edge of the diaphragm and the frame). Materials other than a dielectric may be used as a stiffener.

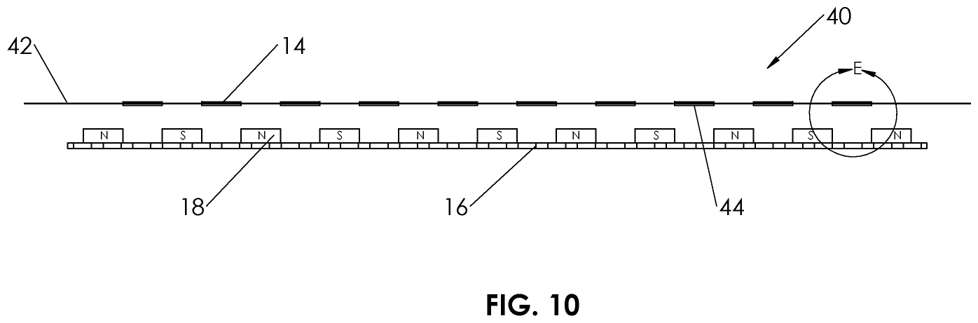

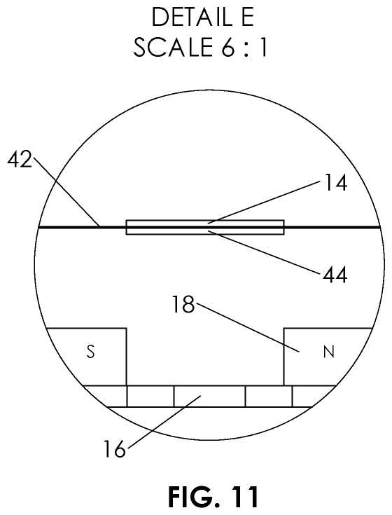

Referring now to FIGS. 10-11, an alternative embodiment of the invention is illustrated. FIGS. 10-11 illustrate a quasi-ribbon speaker 40 that comprises a rear layer and a front layer. The rear layer comprises a perforated metal planar sheet 16 with a plurality of parallel, spaced-apart elongated magnetic bars 18 mounted to the perforated metal sheet. The front layer comprises a flexible planar diaphragm 42 with front electronic traces 14 affixed to the front surface of the diaphragm and rear electronic traces 44 affixed to the rear surface of the diaphragm. Conventional quasi-ribbon speakers comprise electronic traces on only one surface of the diaphragm. Having electronic traces on both sides of the diaphragm improves the performance of the speaker.

In most places, the front and rear electronic traces have the same position, just on opposite sides of the diaphragm (i.e., the front and rear electronic traces are “back-to-back”). At resonance areas, the front and rear electronic traces may both be positioned the same amount over the corresponding respective magnetic bar. However, depending on the amplitude of the resonance, it may be desirable to vary only the position of the front electronic trace or only the position of the rear electronic trace (rather than varying the position of both). Alternatively, depending on the amplitude of the resonance, it may be desirable to vary the position of the front electronic trace and the position of the rear electronic trace by different amounts.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. A quasi-ribbon speaker comprising:
a perforated planar metal sheet;
a plurality of parallel, spaced-apart elongated magnetic bars mounted to the metal sheet in an alternating pole arrangement;
a flexible planar diaphragm positioned parallel to the metal sheet; and
a plurality of electronic traces affixed to the diaphragm;
wherein, except at each of one or more areas of resonance, the electronic traces are parallel to each other and each electronic trace is positioned above a corresponding gap between two adjacent magnetic bars;
wherein at each of the one or more areas of resonance a portion of one or more electronic traces is positioned partly or fully overlapping a portion of one or more of the magnetic bars.

2. The quasi-ribbon speaker of claim 1, further comprising an edge band affixed to an outer perimeter of the diaphragm to enable tensioning of the diaphragm.

3. The quasi-ribbon speaker of claim 2, wherein the edge band comprises a dielectric substrate.

4. The quasi-ribbon speaker of claim 1, wherein the plurality of electronic traces is a first plurality of electronic traces affixed to a first side of the diaphragm; and
wherein the quasi-ribbon speaker further comprises a second plurality of electronic traces affixed to a second side of the diaphragm.

5. The quasi-ribbon speaker of claim 4, wherein the first plurality of electronic traces and the second plurality of electronic traces are positioned fully back-to-back.

6. The quasi-ribbon speaker of claim 4, wherein, except at each of the one or more areas of resonance, the first plurality of electronic traces and the second plurality of electronic traces are positioned back-to-back.

7. A quasi-ribbon speaker comprising:
a perforated planar metal sheet;
a plurality of parallel, spaced-apart elongated magnetic bars mounted to the metal sheet in an alternating pole arrangement;
a flexible planar diaphragm positioned parallel to the metal sheet;
a first plurality of electronic traces affixed to a first side of the diaphragm; and
a second plurality of electronic traces affixed to a second side of the diaphragm.

8. The quasi-ribbon speaker of claim 7, wherein, except at each of one or more areas of resonance, the first plurality of electronic traces are parallel to each other and each of the first plurality of electronic traces is positioned above a corresponding gap between two adjacent magnetic bars; and
wherein at each of the one or more areas of resonance a portion of one or more of the first plurality of electronic traces is positioned partly or fully overlapping a portion of one or more of the magnetic bars.

9. The quasi-ribbon speaker of claim 8, wherein, except at each of the one or more areas of resonance, the second plurality of electronic traces are parallel to each other and each of the second plurality of electronic traces is positioned above a corresponding gap between two adjacent magnetic bars;
wherein at each of the one or more areas of resonance a portion of one or more of the second plurality of electronic traces is positioned partly or fully overlapping a portion of one or more of the magnetic bars.

10. The quasi-ribbon speaker of claim 9, wherein the first plurality of electronic traces and the second plurality of electronic traces are positioned fully back-to-back.

11. The quasi-ribbon speaker of claim 9, wherein, except at each of the one or more areas of resonance, the first plurality of electronic traces and the second plurality of electronic traces are positioned back-to-back.

12. The quasi-ribbon speaker of claim 7, further comprising an edge band affixed to an outer perimeter of the diaphragm to enable tensioning of the diaphragm.

13. The quasi-ribbon speaker of claim 12, wherein the edge band comprises a dielectric substrate.

14. A quasi-ribbon speaker comprising:
a perforated planar metal sheet;
a plurality of parallel, spaced-apart elongated magnetic bars mounted to the metal sheet in an alternating pole arrangement;
a flexible planar diaphragm positioned parallel to the metal sheet;
a plurality of electronic traces affixed to the diaphragm; and
an edge band affixed to an outer perimeter of the diaphragm to enable tensioning of the diaphragm.

15. The quasi-ribbon speaker of claim 14, wherein the edge band comprises a dielectric substrate.

16. The quasi-ribbon speaker of claim 14, wherein, except at each of one or more areas of resonance, the electronic traces are parallel to each other and each electronic trace is positioned above a corresponding gap between two adjacent magnetic bars;
wherein at each of the one or more areas of resonance a portion of one or more electronic traces is positioned partly or fully overlapping a portion of one or more of the magnetic bars.

17. The quasi-ribbon speaker of claim 14, wherein the plurality of electronic traces is a first plurality of electronic traces affixed to a first side of the diaphragm; and
wherein the quasi-ribbon speaker further comprises a second plurality of electronic traces affixed to a second side of the diaphragm.

18. The quasi-ribbon speaker of claim 17, wherein the first plurality of electronic traces and the second plurality of electronic traces are positioned fully back-to-back.

19. The quasi-ribbon speaker of claim 17, wherein, except at each of the one or more areas of resonance, the first plurality of electronic traces and the second plurality of electronic traces are positioned back-to-back.
